(19) United States
(12) Patent Application Publication
(10) Pub. No.: US 2013/0241956 A1
(43) Pub. Date: Sep. 19, 2013

(54) APPARATUS AND METHOD FOR PROVIDING HYBRID FAIRY TALE BOOK IN MOBILE TERMINAL

(71) Applicant: Kyu Dong KIM, Seoul (KR)

(72) Inventor: Kyu Dong KIM, Seoul (KR)

(73) Assignee: JDF Group

(21) Appl. No.: 13/462,071

(22) Filed: May 2, 2012

(30) Foreign Application Priority Data
Mar. 14, 2012 (KR) 10-2012-0026155

(51) Int. Cl. G09G 5/00

(52) U.S. Cl. 345/634; 345/156

(57) ABSTRACT

An apparatus and method for providing a hybrid fairy tale book in a mobile terminal are provided. The apparatus for providing a hybrid fairy tale book in a mobile terminal includes a downloader which downloads a book application selected by a terminal user from a storage server, a processor which displays an input UI on the screen according to an execution instruction for the downloaded book application, and then searches for the content of a first fairy tale book connected with the book application from a paid database in the storage server, when a condition selected by the input UI is met and thus, an authentication code is inputted; and a control display which processes the found content of the first fairy tale book using a personal image, and visualizes the processed content of the first fairy tale book through the book application.

### CROSS-REFERENCE TO RELATED APPLICATIONS

This application claims the priority of Korean Patent Application No. 10-2012-0026155, filed on Mar. 14, 2012, the disclosure of which is incorporated herein by reference,

### BACKGROUND OF THE INVENTION

1. Field of the Invention

Embodiments of the present invention relate to a technology for providing processed content of a fairy tale book using a personal image of a terminal user through a book application.

2. Description of Related Art

A fairy tale book is provided in a variety of types. For example, the fairy tale book may be provided in a type of publication or an e-book. As described herein, the fairy tale book provided in a type of c-book visualizes the content of the fairy tale book as an image, so as to increase a level of enjoyment provided by a type of publication to users.

However, because the users reading the fairy tale book (for example, children) have a low attention span and are easily bored, a technology for providing a fairy tale book that can pique a level of interest in users is needed.

### SUMMARY OF THE INVENTION

An objective of the present invention is to provide the processed content of a fairy tale book using a personal image of a terminal user through a book application, so as to increase the attention span of a user. The impression of the user may be doubled by piquing interest in the fairy tale book and maximizing user empathy for the fairy tale book.

Another objective of the present invention is to display an input user interface (UI) the screen according to an execution instruction for a book application, and visualize the content of a fairy tale book when an authentication code inputted by the input UI is identical to that of a publication corresponding to the content of the fairy tale book and thus, various types of fairy tale books can be supported by providing a fairy tale book in paper type and e-book type to a consumer, thereby providing an environment capable of increasing the sale of the publication.

According to an aspect of the present invention, an apparatus is disclosed for providing a hybrid fairy tale book in a mobile terminal including: a downloader which downloads a book application selected by a terminal user from a storage server; a processor which displays an input UI on the screen according to an execution instruction for the downloaded book application, and then searches for the content of a first fairy tale book connected with the book application from a paid database in the storage server, when the condition selected by the input UI is met and thus an authentication code is inputted; and a control display which processes the found content of the first fairy tale book using a personal image, and visualizes the processed content of the first fairy tale book through the book application.

According to another aspect of the present invention, a method is disclosed for providing a hybrid fairy tale book in a mobile terminal including: downloading a book application selected by a terminal user from a storage server; displaying an input UI on the screen according to an execution instruction for the downloaded book application, and then searching for the content of a first fairy tale book connected with the book application from a paid database in the storage server, when the condition selected by the input UI is met and thus an authentication code is inputted; and processing the found content of the first fairy tale book using a personal image, and visualizing the processed content of the first fairy tale book through the book application.

According to an embodiment of the present invention, the processed content of a fairy tale book is provided using a personal image of a terminal user through a book application, so as to increase the attention span of a user on the airy tale book and the impression of the user to be doubled by piquing the interest of a terminal user in the fairy tale book and maximizing empathy of the user for the fairy tale book.

According to an embodiment of the present invention, an input UI is displayed on the screen according to an execution instruction for a book application, and the content of a fairy tale book is visualized, when an authentication code inputted by the input UI is identical to that of a publication corresponding to the content of the fairy tale book, and thus various types of fairy tale books can be supported by providing a fairy tale book in paper type and e-book type to a consumer, thereby providing an environment capable of increasing the sale of the publication.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of a system for providing a hybrid fairy tale book in a mobile terminal according to an embodiment of the present invention;

FIG. 2 is a diagram illustrating a configuration of an apparatus for providing a hybrid fairy tale book in a mobile terminal according to an embodiment of the present invention;

FIG. 3 is a diagram illustrating an example for visualizing the content of a fairy tale book in an apparatus for providing a hybrid fairy tale book in a mobile terminal according to an embodiment of the present invention;

FIG. 4 is a diagram illustrating an example for visualizing the content of a fairy tale book in an apparatus for providing a hybrid fairy tale book in a mobile terminal according to an embodiment of the present invention; and

FIG. 5 is a flowchart illustrating a method for providing a hybrid fairy tale book in a mobile terminal according to an embodiment of the present invention.

### DETAILED DESCRIPTION OF THE INVENTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Hereinafter, an apparatus and method for providing a hybrid fairy tale book in a mobile terminal according to an embodiment of the invention will be described in detail with reference to the accompanying drawings. As described herein, although the apparatus for providing a hybrid fairy tale book in a mobile terminal may be included in a mobile terminal, it is not limited thereto.

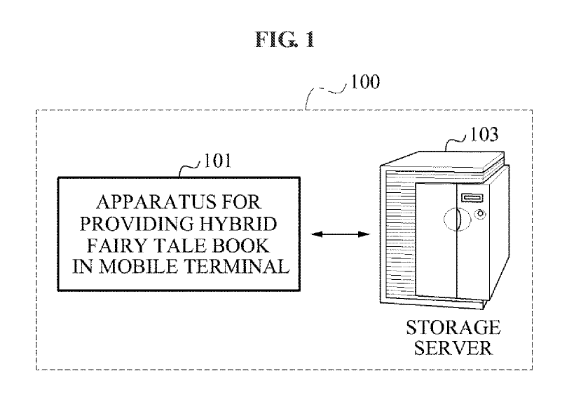

FIG. 1 is a diagram illustrating a configuration of a system for providing a hybrid fairy tale book in a mobile terminal according to an embodiment of the present invention.

Referring to FIG. 1, the system for providing a hybrid fairy tale book in a mobile terminal 100 according to an embodiment of the present invention includes an apparatus for providing a hybrid fairy tale book in a mobile terminal 101 and a storage server 103.

The apparatus for providing a hybrid fairy tale book in a mobile terminal 101 may download a book application by making a request for downloading the book application to the connected storage server 103, and then make another request for the content of a fairy tale book connected with the book application to the storage server 103 according to an execution instruction for the downloaded book application. The apparatus for providing a hybrid fairy tale book 101 may process the content of the fairy tale book, which is provided from the storage server 103, using a personal image, for example, the facial image of a terminal user, and visualize the processed content of the fairy tale book through the book application.

For example, the apparatus for providing a hybrid fairy tale book 101 displays an input on the screen according to an execution instruction for the book application, and may receive the content of the first fairy tale book stored in a paid database, from the storage server 103, when a condition selected by the input UI (for example, when an authentication code inputted by the input UI is searched from the paid database in the storage server) is met and an authentication code is inputted. In the course of this, the authentication code may be inputted by the terminal user that recognizes it through a publication corresponding to the content of the first fairy tale book.

Conversely, when the condition selected by the input UI is met and the authentication code fails to be inputted, the apparatus for providing a hybrid fairy tale book 101 may receive the content of a second fairy tale book stored in a free database, for example, a part of the content of the first fairy tale book, from the storage server 103.

The apparatus for providing a hybrid tale book 101 may produce a fairy tale book in paper type by scanning and outputting, in response to a content output request.

The storage server 103 may provide the book application to the apparatus for providing a hybrid fairy tale book 101 in response to the request for downloading the book application being received from the apparatus for providing a hybrid fairy tale book 101.

The storage server 103 may also provide the content of a fairy tale book to the apparatus for providing a hybrid fairy tale book 101 according to a request for the content of the fairy tale book, which is connected with the book application, from the apparatus for providing a hybrid. fairy tale book 101.

Herein, the storage server 103 receives the authentication code from the apparatus for providing a hybrid fairy tale book 101, and when the received authentication code is searched in the paid database, the storage server may search the content of the first fairy tale book corresponding to the authentication code in the paid database, and then provide the found content to the apparatus for providing a hybrid fairy tale book 101. On the other hand, when the authentication code received from the apparatus for providing a hybrid fairy tale book 101 fails to be found in the paid database, the storage server 103 may search the content of the second fairy tale book from the free database, and then provide the found content to the apparatus for providing a hybrid fairy tale book 101.

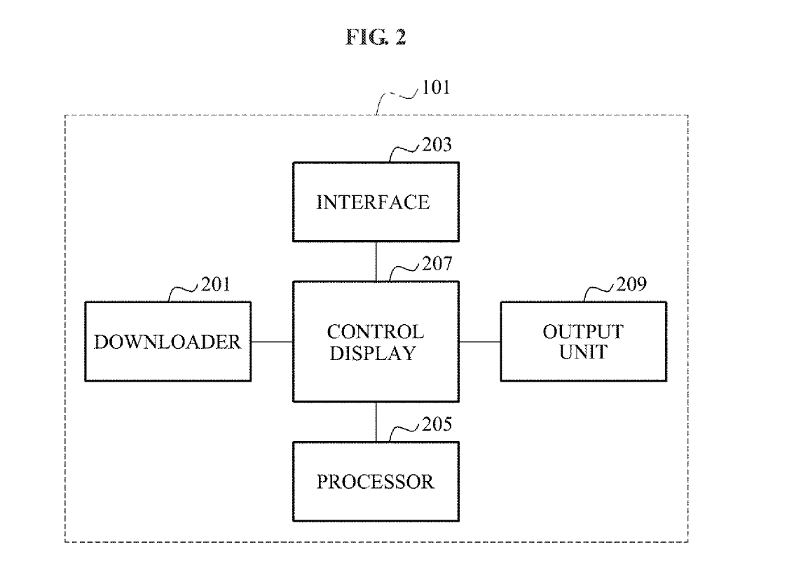

FIG. 2 is a diagram illustrating a configuration of an apparatus for providing a hybrid fairy tale book in a mobile terminal according to an embodiment of the present invention.

An apparatus for providing a hybrid fairy tale book in a mobile terminal 101 may visualize the content of a fairy tale book, by receiving the content from a storage server. Here, the storage server may include a paid database and a free database.

As an example, the paid database may match an authentication code, which is issued when a publication corresponding to the content of the first fairy tale book is produced, with the content of the first fairy tale book, and then store the authentication code. In this example, the authentication code may be printed in the publication. Accordingly, a terminal user may acquire the authentication code printed in the publication after a purchase is made.

In addition, the paid database may further match identification information of a terminal user that bought the publication with the content of the first fairy tale book, and then stores the information.

The free database may store the content of a second fairy tale book as a part of the content of the first fairy tale book.

Referring to FIG. 2, the apparatus for providing a hybrid fairy tale book in a mobile terminal 101 according to an embodiment of the present invention includes a downloader 201, an interface 203, a processor 205, a control display 207, and an output unit 209.

The downloader 201 downloads the book application, which is selected by a terminal user, from the storage server.

When the book application is downloaded, the downloader 201 may selectively perform payment for the book application. In the course of this, provided that the payment for the book application is completed in the apparatus for providing a hybrid fairy tale book in a mobile terminal 101, the storage server may acquire identification information of the terminal user, for example, an identification number of a terminal, and record the acquired information in the paid database.

The interface 203 acquires an image taken by a camera as personal images, or determines an image extracted from a memory by an instruction to be a personal image. That is, at the time of the book application execution, the interface 203 may acquire an image taken by a camera as the personal image or determine an image pre-stored in a memory as the personal image in interaction with the above execution.

As an example, the interface 203 may acquire a facial image of a person taken by a camera, which provides characters in the content of the fairy tale book as a background image, as the personal image.

When n personal images are acquired, the interface 203 may receive the respective characters, which are selected as ones matching the a personal images, among the characters in the content of the first fairy tale book connected with the book application. Here, n represents a natural number.

The processor 205 displays an input UI on the screen according to an execution instruction for the downloaded book application, and may search the content of the fairy tale book from the paid database or the free database in the storage server based on whether a condition selected by the input UI is met and thus the authentication code is inputted. When the authentication code inputted through the input UI by the terminal user recognizes the authentication code through the publication corresponding to the content of the fairy tale book, is found in the paid database, the processor 205 may determine that the authentication code is inputted, because the condition is met.

That is, provided that the condition selected by the input UI is met and thus the authentication code is inputted, the processor 205 searches for the content of the first fairy tale book connected with the book application (or the content of the first fairy tale book connected with the authentication code) from the paid database in the storage server. Conversely, when the condition selected by the input UI is met and the authentication code fails to be inputted, the processor 205 may search for the content of a second fairy tale book as a part of the content of the first fairy tale book from the free database in the storage server. That is, the authentication code printed in the publication fails to be inputted by the input UI, so that the processor 205 may search the content of the second fairy tale book for a trial version.

When the condition selected by the input UI is met and the authentication code is inputted, the control display 207 processes the found content of the first fairy tale book using a personal image, and visualizes the processed content of the first fairy tale book through the book application. In other words, the authentication code printed in the publication is inputted by the input UI, so that the control display 207 may provide the content of the first fairy tale book for a full version.

The control display 207 may process the content of the fairy tale book by replacing faces of the characters, which are found in the content of the first fairy tale book, with the personal images. In other words, the control display 207 may process the content of the fairy tale books by replacing faces of the characters in the content of the first fairy tale book with personal images of the terminal user or close friends, and then provide the processed content of the fairy tale book, so as to pique the interest of the user and maximize the empathy of the user for the fairy tale book.

That is, the control display 207 may identify a gender related to the personal image, for example, gender may be identified based on the analysis result of the personal image or inputted by the terminal user, and then replace the face of the main character among the characters in the fairy tale book with the personal image, according to the identified gender. For example, when gender for the personal image is male, the control display 207 may replace the face of the main character ‘prince’ with the personal image.

In addition, when the number of personal images is n, the control display 207 may replace the respective faces of the characters with the n personal images inputted by the interface 203, based on the characters that are selected as matching the n personal images. Here, n represents a natural number. For example, when there are three personal images, the control display 207 may receive a ‘first character’ selected as one matching a ‘first personal image’, a ‘second character’ selected as one matching a ‘second personal image’, and a ‘third character’ selected as one matching a ‘third personal image’, and then replace the faces of the ‘first to third characters’ with the ‘first to third personal images’ respectively, based on the selections.

Accordingly, the control display 207 replaces the respective faces of the characters in the content of the first fairy tale book with the personal images of the terminal user as well as close friends, so as to give the fairy tale book an appearance of watching a theatrical production.

When the condition selected by the input UI is met and the authentication code fails to be inputted, the control display 207 may visualize the content of the second fairy tale book, which is searched for by the processor 205, through the book application, in this instance, when the authentication code printed in the publication fails to be inputted through the input UI, the control display 207 may provide the content of the second fairy tale book in a form of a trial version. Although the control display 207 may provide the unprocessed content of the second fairy tale book, and also provide the content of the second fairy tale book by replacing the faces of the characters in the content of the second fairy tale book with the personal images, it is not limited thereto.

The control display 207 provides the content of the second fairy tale book for trial version, to promote purchasing a publication by providing an authentication code to acquire the content of the second fairy tale book for a full version.

As an example, when identification information of the terminal visualizing the content of the first fairy tale book is searched for in the paid database of the storage server, the control display 207 may permit the visualization. In other words, payment for the book application is performed at the time at which the book application is downloaded. In this instance, when identification information of the terminal user stored in the paid database matches that of the terminal visualizing the content of the first fairy tale book, the control display 207 may omit a process for inputting the authentication code, because the payment is already completed.

The output unit 209 allows users to produce a fairy tale book in paper type, by making the content of the first fairy tale book connected with the book application to be scanned and outputted by means of an output device, so that the users may have extra fairy tale books except the bought publication.

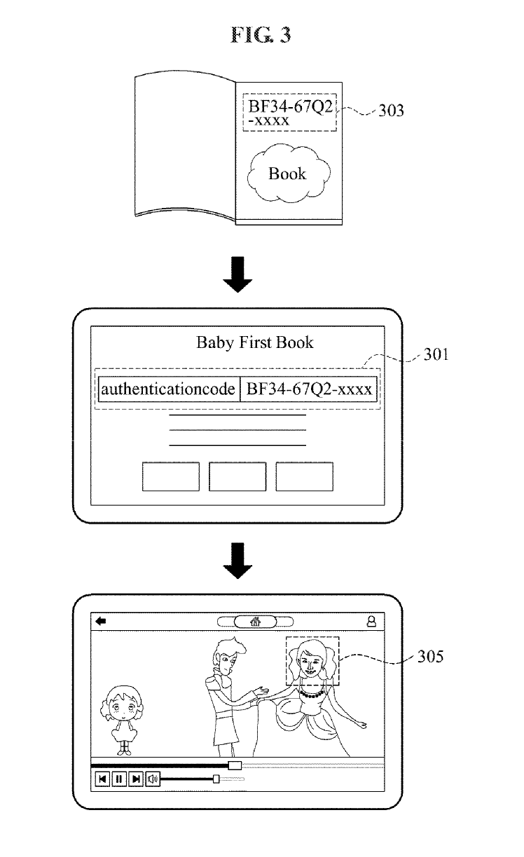

FIG. 3 is a diagram illustrating an example for visualizing the content of a fairy tale book in an apparatus for providing a hybrid fairy tale book in a mobile terminal according to an embodiment of the present invention.

Referring to FIG. 3, the apparatus for providing a hybrid fairy tale book displays an input on the screen according to an execution instruction for a book application, and when a condition selected by the input UI and thus an authentication code is inputted, the apparatus may search for the content of the first fairy tats book connected with the book application from a paid database in the storage server, and then visualize the found content.

For example, the apparatus for providing a hybrid fairy tale book displays the input UI on the screen according to the execution instruction for the book application, and when an authentication code inputted by the input UI, for example, ‘BF34-67Q2-XXXX’ 301, is searched for in the paid database in the storage server, the apparatus may find the content of the first fairy tale book connected with the book application in the paid database, and then visualize the found content. Herein, the authentication code may be inputted by a terminal user that recognizes an authentication code 303 through a publication corresponding to the content of the first fairy tale book.

Herein, the apparatus for providing a hybrid fairy tale book may process the found content of the first fairy tale book using a personal image, and visualize the processed content of the first fairy tale book through the book application. For example, the apparatus for providing a hybrid fairy tale book may process the content of the first fairy tale book by replacing the face of a character in the found content of the first fairy tale book with the personal image of the terminal user, for example, ‘Anna’, 305 and then visualize the processed content of the first fairy tale book through the book application.

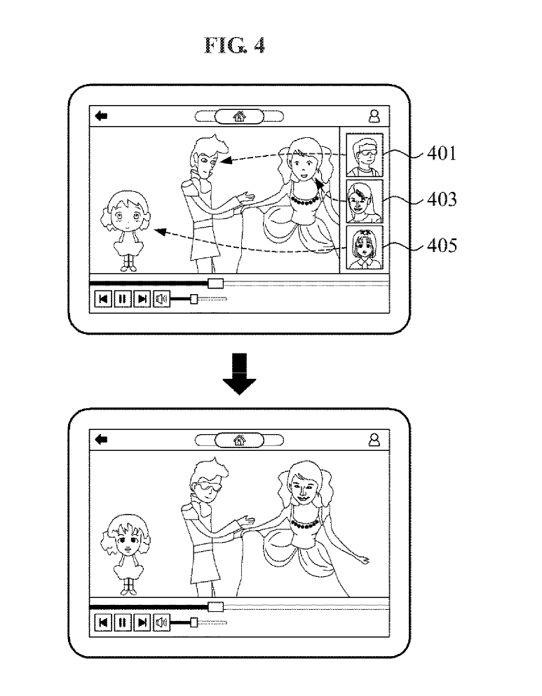

FIG. 4 is a diagram illustrating an example for visualizing the content of a fairy tale book in an apparatus for providing a hybrid fairy tale book in a mobile terminal according to an embodiment of the present invention.

Referring to FIG. 4, the apparatus for providing a hybrid fairy tale book may search for the content of the first fairy tale book connected with the book application from a paid database in the storage server according to an execution instruction for the book application, and process the found content of the first fairy tale book using the personal image, and then provide the processed content after visualizing the same.

Here, when the number of personal images is n where n represents a natural number, the apparatus for providing a hybrid fairy tale book may receive the respective characters, which are selected as ones matching the n personal images, among characters in the content of the first fairy tale book, and then process the content of the first fairy tale book by replacing the respective faces of the characters with the n personal images, based on the selection. When the number of personal images is n where n represents a natural number, the apparatus for providing a hybrid fairy tale hook may provide a list of personal images as well as a list of characters, and the apparatus may also receive matching lines connecting the personal images and the characters, or the respective characters which are selected as matching the n personal images, by dragging the personal images to the matching characters.

For example, in a case in which three personal images are acquired, the apparatus for providing a hybrid fairy tale book may display the three personal images 401, 403, and 405 as well as the characters simultaneously. Here, the faces of the characters may be replaced with the respective personal images 401, 403, and 405 by dragging each of the personal images 401, 403, and 405 to the corresponding character.

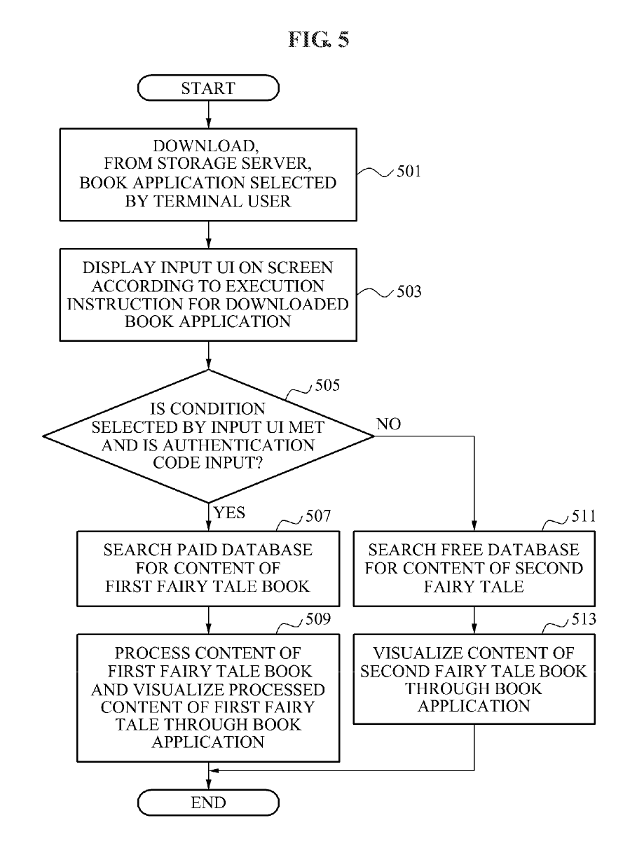

FIG. 5 is a flowchart illustrating a method for providing a hybrid fairy tale book in a mobile terminal according to an embodiment of the present invention.

Referring to FIG. 5, in operation 501, the apparatus for providing a hybrid fairy tale book downloads the book application, which is selected by a terminal user, from a storage server.

In operation 503, the apparatus for providing a hybrid fairy tale book displays an input UI on the screen according to an execution instruction for the downloaded book application.

In operation 505, the apparatus for providing a hybrid fairy tale book determines whether a condition selected by the input UI is met and thus an authentication code is inputted. In this instance, when an authentication code, which is inputted through the input UI by the terminal user that recognizes the authentication code through a publication, is searched for in the paid database, the apparatus for providing a hybrid fairy tale book may determine that the condition is met and thus, the authentication code is inputted. Here, the paid database may store an authentication code, which is issued when a publication corresponding to the content of the first fairy tale book is produced (the authentication code is printed in the publication), by matching the authentication code to the content of the first fairy tale book.

In operation 507, when the condition selected by the input UI is met and thus the authentication code is inputted, the apparatus for providing a hybrid fairy tale book searches for the content of the first fairy tale book connected with the book application (or the content of the first fairy tale book connected with the authentication code) from a paid database in the storage server.

In operation 509, the apparatus for providing a hybrid fairy tale book processes the found content of the first fairy tale book using the personal image, and visualizes the processed content of the first fairy tale book through the book application. As an example, the apparatus for providing a hybrid fairy tale book may acquire an image taken by a camera as the personal image, or determine an image extracted from a memory by an instruction as the personal image.

That is, the apparatus for providing a hybrid fairy tale book may process the content of the fairy tale book by replacing faces of the characters in the content of the first fairy tale book with the personal images. In this instance, the apparatus fir providing a hybrid fairy tale book may identify a gender related to the personal image (for example, the gender may be identified based on a result of analyzing the personal image, or inputted by the terminal user), and then replace the face of the main character among the characters with the personal image, based on the identified gender.

In addition, when the number of personal images is n where n represents a natural number, the apparatus for providing a hybrid fairy tale book may receive the respective characters which are selected as matching the n personal images, and replace the respective faces of the characters with the n personal images, based on the selection.

When the condition selected by the input UI is met and the authentication code fails to be inputted in operation 505, the apparatus for providing a hybrid fairy tale book may search. for the content of a second fairy tale book as a part of the content of the first fairy tale book from the free database in the storage server, in operation 511.

In operation 513, the apparatus for providing a hybrid fairy tale book may visualize the found content of the second fairy tale book through the book application.

In addition, when identification information of a terminal, which visualizes the content of the first fairy tale book connected with the book application, is found in a paid database of the storage server, the apparatus for providing a hybrid fairy tale book may permit the visualization. Conversely, the payment for the book application is performed at the time of the book application downloading. When identification information of a terminal user stored in the paid database matches that of the terminal visualizing the content of the first fairy tale book, a process for inputting the authentication code may be omitted, because the payment is already completed.

Alternatively, the apparatus for providing a hybrid fairy tale book allows users to produce fairy tale books in paper type by making the content of the first fairy tale book with the book application to be scanned and outputted by an output device.

The above-described embodiments of the present invention may be recorded in computer-readable media by being implemented in u form of program instructions, which may be executed through various computer means. The media may include, alone or by being engaged with the program instructions, data files, data structures, and the like. The program instructions recorded in the media are especially designed and configured for the invention, or known to those skilled in the art of computer software for availability. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for providing a hybrid fairy tale book in a mobile terminal, the apparatus comprising:
a downloader to download a book application selected by a terminal user from a storage server;
a processor to display an input UI on the screen according to an execution instruction for the downloaded book application, and then to search for the content of a first fairy tale book connected with the book application from a paid database in the storage server, when a condition selected by the input UI is met and an authentication code inputted; and
a control display to process the found content of the first fairy tale book using a personal image, and to visualize the processed content of the first fairy tale book through the book application.

2. The apparatus of claim 1, further comprising:
an interface to acquire an image taken by a camera as the personal image, or to determine an image extracted from a memory by an instruction to be the personal image, wherein the control display processes the content of the fairy tale book by replacing the faces of characters in the content of the first fairy tale book with the personal image.

3. The apparatus of claim 1, wherein when the condition selected by the input UI is met and the authentication code fails to be inputted, the processor searches the content of a second fairy tale book as a part of the content of the first fairy tale book from a free database in the storage server, and the control display visualizes the found content of the second fairy tale book through the book application.

4. The apparatus of claim 1, wherein the paid database stores an authentication code, which is issued when a publication corresponding to the content of the first fairy tale book is produced (the authentication code is printed in the publication), by matching the authentication code to the content of the first fairy tale book, and the processor determines that the condition is met and the authentication code is inputted, when the authentication code, which is inputted by the terminal user that recognizes the authentication code through the publication, is found in the paid database.

5. The apparatus of claim 4, wherein the paid database further matches identification information of a terminal user that bought the publication with the content of the first fairy tale book and then stores the identification information, and when identification information of a terminal visualizing the content of the first fairy tale book is found in the paid database, the control display permits the visualization.

6. The apparatus of claim 2, wherein the processor identifies a gender for the personal image, and then replaces a face of a main character among the characters with the personal image according to the identified gender.

7. The apparatus of claim 2, wherein when the number of personal images is n (n represents a natural number), the interface receives the respective characters, which are selected as matching the n personal images, and the control display replaces the faces of the characters with the n personal images, based on the selection.

8. The apparatus of claim 1, the apparatus further comprising an input to allow the content of the first fairy tale book to be scanned and outputted by means of an output device.

9. A method for providing a hybrid fairy tale book in a mobile terminal, the method comprising:
downloading a book application selected by a terminal user from a storage server;
displaying an input UI on the screen according to an execution instruction for the downloaded book application, and then searching for the content of a first fairy tale book connected with the book application from a paid database in the storage server, when a condition selected by the input UI is met and an authentication code inputted; and
processing the found content of the first fairy tale book using a personal image, and visualizing the processed content of the first fairy tale book through the book application.

10. The method of claim 9, further comprising:
acquiring an image taken by a camera as the personal image, or determining an image extracted from a memory as the personal image;
wherein the visualizing of the processed content of the first fairy tale book comprises processing the content of the fairy tale book by replacing faces of the characters in the content of the first fairy tale book with the personal images, and then providing the processed content.

11. The method of claim 9, further comprising:
searching for the content of a second fairy tale book as a part of the content of the first fairy tale book from a free database in the storage server, when the condition selected by the input UI is met and the authentication code fails to be inputted; and
visualizing the found content of the second fairy tale book through the book application.

12. The method of claim 9, further comprising:
storing an authentication code, which is issued when a publication corresponding to the content of the first fairy tale book is produced, in the paid database by matching the authentication code to the content of the first fairy tale book; and
determining that the condition is met and thus the authentication code is inputted, when the authentication code, which is inputted by the terminal user that recognizes the authentication code through the publication, is searched in the paid database.

13. The method of claim 10, wherein the processing and providing of the content of the fairy tale book comprises identifying a gender for the personal image and then replacing a face of a main character among the characters with the personal image according to the identified gender.

14. The method of claim 10, wherein processing and providing of the content of the fairy tale book comprises receiving characters which are selected as matching the n personal images, when the number of the personal images is n, where n represents a natural number, and then replacing the faces of the characters with the n personal images, based on the selection.

15. The method of claim 9, further comprising:
allowing the content of the first fairy tale book to be scanned and outputted by means of an output device.
